(19) United States
(12) Patent Application Publication
(10) Pub. No.: US 2021/0410233 A1
(43) Pub. Date: Dec. 30, 2021

(54) HEATER

(71) Applicant: Shenzhen Eigate Technology Co., Ltd., Shenzhen (CN)

(72) Inventor: Tuanfang LIU, Shenzhen (CN)

(21) Appl. No.: 17/120,245

(22) Filed: Dec. 13, 2020

(30) Foreign Application Priority Data
Jun. 29, 2020 (CN) 202010607045.0
Jun. 29, 2020 (CN) 202021227124.0

(51) Int. Cl. H05B 3/26; A24F 40/46; A24F 40/10

(52) U.S. Cl. CPC H05B 3/265; A24F 40/10; A24F 40/46

(57) ABSTRACT

A heater includes a ceramic core and a heating wire. The ceramic core includes a concave bottom end.

### CROSS-REFERENCE TO RELATED APPLICATIONS

Pursuant to 35 U.S.C. § 119 and the Paris Convention Treaty, this application claims foreign priority to Chinese Patent Application No. 202010607045.0 filed on Jun. 29, 2020, and to Chinese Patent Application No. 202021227124.0 filed on Jun. 29, 2020. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to a heater.

Conventionally, a heater comprises a ceramic core and a heating wire. The ceramic core is a cylinder comprising one or two through holes and the heating wire passes through the through holes to be secured to the ceramic core. In this way, the e-liquid in the ceramic core directly contacts the heating wire and tends to deposit on the heating wire to form dirt.

### SUMMARY

The disclosure provides a heater comprising a ceramic core and a heating wire; the ceramic core comprises a concave bottom end.

In a class of this embodiment, the heating wire is secured to the concave bottom end of the ceramic core.

In a class of this embodiment, the ceramic core is cylindrical, and the heating wire is bended back and forth to form a planar disk.

In a class of this embodiment, the ceramic core comprises a side wall comprising a plurality of evenly-distributed grooves.

### BRIEF DESCRIPTION OF THE DRAWINGS

FIG. 1 is a schematic diagram of a heater in accordance with one embodiment of the disclosure;

FIG. 2 is another schematic diagram of a heater in accordance with one embodiment of the disclosure; and

FIG. 3 is a sectional view of a heater in accordance with one embodiment of the disclosure.

### DETAILED DESCRIPTION

To further illustrate, embodiments detailing a heater are described below. It should be noted that the following embodiments are intended to describe and not to limit the disclosure.

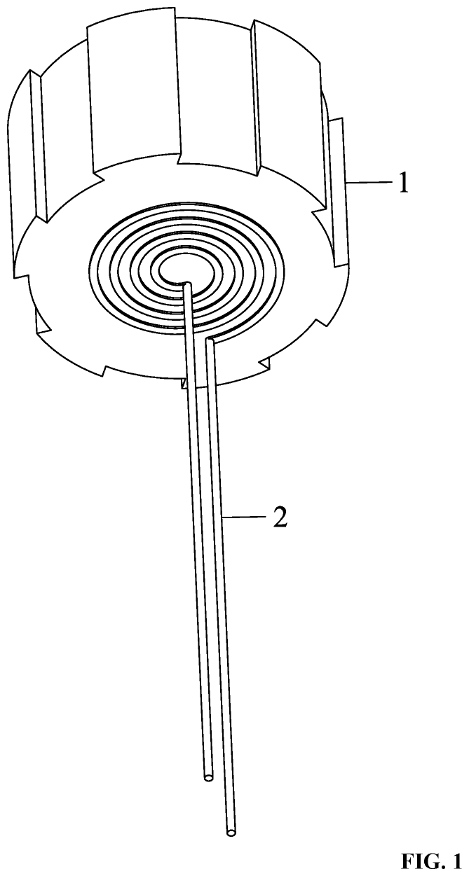

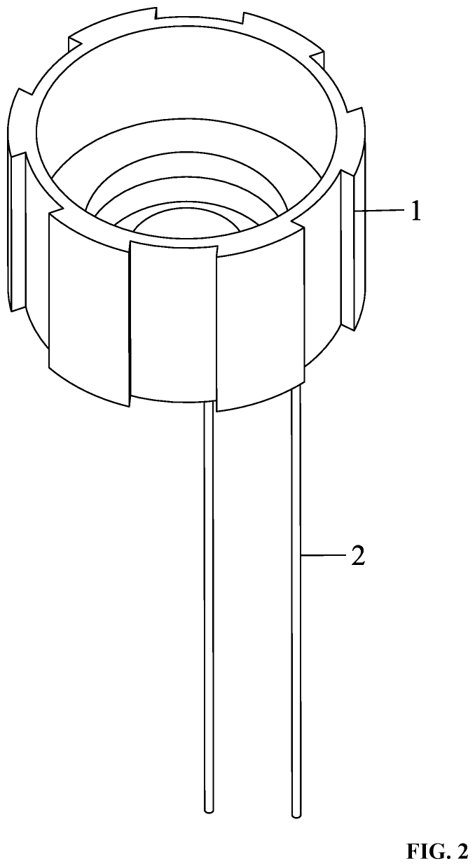

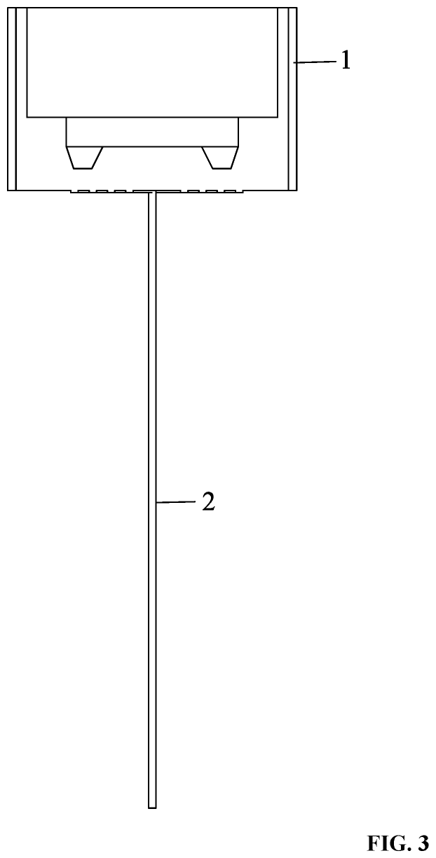

As shown in FIGS. 1-3, the disclosure provides a ceramic atomizer comprising a ceramic core 1 and a heating wire 2. The ceramic core 1 is a cylinder comprising a concave bottom end and a side wall comprising a plurality of grooves. The heating wire 2 is a disk-shaped planar wire disposed on the concave bottom end of the ceramic core. When current flows through the heating wire, the heating wire 2 is heated. The heating wire transfers the heat to the ceramic core 1 to atomize the e-liquid in the concave bottom end. In this way, the e-liquid does not directly contact the heating wire 2, so no dirt deposits on the heating wire 2.

In certain embodiments, the ceramic core 1 is replaced with quartz, crystal, mica, jade and other materials. The ceramic core 1 is square, hemispherical, conical, polygonal and comprises the concave bottom end. The heating wire 2 comprises two or more planar or square disk-shaped or mesh-shaped metal wires, disposed under the bottom end of the ceramic core 1 or surrounds the ceramic core 1.

The following advantages are associated with the heater of the disclosure:

1. The ceramic core is cylindrical and comprises a concave bottom end. When used in an atomizer, the e-liquid is uniformly dispersed in the ceramic core, thus enlarging the coverage area of the e-liquid, so that the e-liquid is uniformly heated to produce much more vapor.

2. The heating wire is bended back and forth to form a planar disk secured to the ceramic core. The design is novel.

It will be obvious to those skilled in the art that changes and modifications may be made, and therefore, the aim in the appended claims is to cover all such changes and modifications.

What is claimed is:

1. A device, comprising a ceramic core and a heating wire, wherein the ceramic core comprises a concave bottom end.

2. The device of claim 1, wherein the heating wire is secured to the concave bottom end of the ceramic core.

3. The device of claim 2, wherein the ceramic core is cylindrical, and the heating wire is bended back and forth to form a planar disk.

4. The device of claim 3, wherein the ceramic core comprises a side wall comprising a plurality of evenly-distributed grooves.
